(19) United States
(12) Patent Application Publication
(10) Pub. No.: US 2007/0184213 A1
(43) Pub. Date: Aug. 9, 2007

(54) Method for manufacturing coated aluminium alloy strips for producing photographic quality decorations by dry transfer

(76) Inventors: Laura Cecchetto, Grenoble (FR); Gianfranco Maggi, Zoccorino (IT)

Correspondence Address: BANNER & WITCOFF, LTD., TEN SOUTH WACKER DRIVE, SUITE 3000, CHICAGO, IL, 60606, US

(21) Appl. No.: 11/570,804

(22) PCT Filed: Jun. 16, 2005
(86) PCT No.: PCT/FR05/01509

§ 371 Date: Dec. 18, 2006

(30) Foreign Application Priority Data
Jun. 18, 2004 (FR) 0406621

(51) Int. Cl. B44F 1/10; B05D 7/00; G11B 11/105

(52) U.S. Cl. 428/29; 427/409; 428/332; 428/457

(57) ABSTRACT

The invention relates to a method for continuously producing an aluminium alloy strip for transferring a sublimable decoration from a temporary carrier consisting in using the aluminium alloy strip having a gloss and high-gloss quality, in anodizing and sealing said strip and in coating the anodized strip with a transparent lacquer consisting of a polyester and polyurethane mixture. Said anodisation and sealing are substitutable by a HELIA process under EP 0 745 703 patent in order to form a compact oxide barrier whose thickness ranges from 140 to 200 nm. The thus produced aluminium alloy strip for sublimation transfer and a strip or sheet decorated after said transfer from the temporary carrier are also disclosed.

### FIELD OF THE INVENTION

The invention relates to a method for continuous industrial manufacture of aluminium alloy strips coated with a varnish, which are particularly suitable for obtaining photographic quality decorations using the dry transfer technique via sublimation from a temporary carrier, as well as the strips manufactured according to this method.

### PRIOR ART

The dry transfer of decorations via sublimation from a temporary carrier found its first important applications in the natural and then synthetic textile industries.

According to this method, the image to be transferred is, in the majority of cases, printed onto a paper carrier using conventional printing techniques. To produce the transfer, said carrier is pressed, while on the press, against the material onto which the sublimable image is to be transferred, for approximately 30 seconds, generally at temperatures of 200 to 230° C. The components of the inks composing the image then pass immediately from the solid state to the gaseous state and migrate towards the carrier to be printed, upon which they condense and are absorbed. During cooling, the ink vapors return immediately to the solid state.

The application was then extended to other materials including polymers and metals.

In the case of aluminium alloys, a pre-transfer anodizing treatment is usually carried out for the purpose of making the transferred decoration hold.

U.S. Pat. No. 3,484,342 (Martin-Marietta Corp.), filed in 1966, discloses the method of transferring decorations via sublimation from a temporary substrate (paper, according to claim 6), onto alloys coated with a anodic layer, which is porous, in order to enable penetration of the various pigments into the pores, and which, after transfer, and sealed (by treating with boiling water, or boehmiting, according to claim 6), in order to fix said pigments to their new substrate.

Claim 4 preferentially cites anodization in a sulphuric medium; in column 4, lines 63 to 66, the description specifies that, after sealing in boiling water for one half-hour, an operation known by the name of boehmiting, the quality and clarity of the dye remain “acceptable”.

Among the disadvantages of this method, it may indeed be pointed out that, depending on their size, all of the pigments do not penetrate into the pores in the same way, some producing a chalking effect by accumulating on the surface, which adversely affects definition of the image and, above all, causes a change in, or even a loss of color after sealing.

Furthermore, it is frequently observed that not only the image of the decoration, but also other undesirable elements (texture of the paper, etc.) are transferred onto the unsealed layers.

In addition, handling operations performed between anodization and transfer as well as between transfer and sealing must be carried out with the utmost of care in order to prevent the pores from becoming easily damaged.

On the other hand, the transfer must be carried out over a brief and relatively constant period of time after anodization (preferably immediately following anodization) the pores becoming sealed naturally by the formation of aluminium hydroxide (Al₂O₃, (H₂O)x).

Finally, in order to obtain an acceptable degree of color intensity, i.e., adequately sized pores, the thickness of the anodic layer must be relatively large (more than 2 to 3 μm, or even 7 μm for blue and black) and, during the heat sublimation operation, a crazing of this type of layer is commonly observed.

Patent application FR 2,230,794 (Sublistatic Holding S.A.), filed in 1974, discloses the application of this method, at a temperature between 140 and 300° C., preferably between 180 to 230° C., to any rigid material consisting of or pre-coated with transparent or colored epoxy resins.

Among a larger number of other substrates, aluminium is cited with respect to household appliances, furniture, automobile sheet metal, but without any indication concerning pre-treatment of the surface to enable adhesion of said epoxy resins. As said adhesion is known to be difficult in the case of aluminium, the treatment in question consists of either conventional anodization or chemical conversion, in order to obtain a porous layer at least on the surface, so as to bond the resin, with all of the disadvantages already described with respect to this type of surface.

It is further known that aluminium alloy surfaces that are “bare” or naturally coated with oxide having a thickness of a few nm are by nature uneven and, when varnished without any other treatment, are fragile and in particular very susceptible to scratching.

The patent EP 0,012,831 B1 (Fromson, Howard A.), filed in 1979, discloses a sublimatic transfer method, at a temperature preferentially between 121 and 218° C., on an aluminium substrate comprising a porous oxide layer that is unsealed and coated with a transparent or colored polymer.

The pigments pass through the polymer material and condense in this coating as well as in the pores of the anodic layer.

The disadvantages already pointed out remain, for all intents and purposes, being linked to the fixing of the pigments inside the pores of the anodic layer and to the customary thickness thereof.

Problem Posed

The applicant has therefore sought to obtain a resistant substrate (as concerns scratching as well as corrosion and aging, in particular), which enables sublimation transfer without any crazing or visible modification in the color and definition of the image transferred (so-called photographic quality), with a non-limiting palette of pigments, and which permits subsequent folding or shaping operations without any apparent degradation.

### OBJECT OF THE INVENTION

The object of the invention is the continuous manufacture of an aluminium alloy strip with a surface that has been optimized for the transfer of a sublimable decoration from a temporary carrier, comprising:
a. The preparation of a highly reflective aluminium alloy strip having a “glossy” or “high gloss” quality,
b. The possible degreasing and chemical polishing or advantageously electropolishing of said strip,
c. The creation of a non-porous surface layer, either by conventional anodization, in order to form an oxide layer having a thickness less than or equal to 1 μm, followed by a sealing operation, via boehmiting in particular, or advantageously by electrolytic superfinishing, i.e., by anodizing in a mineral, organic or compound acid, in order to form a compact, barrier-type layer having a thickness preferably ranging between 140 and 200 nm,
d. The coating of the sealed anodized or barrier-type strip with a transparent varnish having a polyester and polyurethane mixture base.

In the case of the formation of a barrier-type layer, this step may be preceded by deoxidation, also called selective stripping, of the previously formed oxide layer, in a phosphoric acid/chromic acid solution.

Advantageously, the selective stripping and electrolytic superfinishing steps may be repeated.

The varnish is preferentially glossy, of the BASF C1490-0005 type, or flat, of the BASF C149-0004 type.

Another object of the invention is the strip treated and coated according to the above method or its alternatives, thus prepared for application to sublimation transfer, after said strip has possibly been cut into sheets, as well as the decorated strip or sheet, after said transfer from a temporary carrier.

### DISCLOSURE OF THE INVENTION

The invention consists in using “glossy” or “high gloss” quality aluminium alloy strips, in continuously subjecting them, after possible degreasing and chemical polishing or electropolishing, to an anodizing treatment on a thin layer having a thickness less than 1 μm, followed by an operation for sealing the pores by continuous immersion preferably in boiling water, an operation known by the name of boehmiting, prior to coating them advantageously continuously with varnish having a polyester and polyurethane mixture base, according to the type of coating technique known by those skilled in the art as “coil coating”.

The non-porous surfaced anodic layer obtained prior to final varnishing may advantageously be a compact barrier-type layer obtained via the HELIA® method, which is an object of the applicant's patent EP 0,745,703, which is applied to “glossy” or “high gloss” quality strips and whose primary steps, after possible degreasing, are recalled hereinbelow:

A first conventional polishing step with chemicals or preferably electropolishing, then washing with water,

A possible deoxidation or selective stripping step, e.g., in a phosphoric acid/chromic acid medium (H₃PO₄+CrO₃), then washing with water,

A final step, as described in detail in the patent EP 0,745,073, of superfinishing via anodization in a mineral, organic or compound acid, in order to form a barrier layer having a thickness ranging preferably between 100 and 500 nm, and more preferably between 140 and 200 nm.

These two last steps may possibly be repeated in order to obtain optimal optical reflectivity (greater than 80% without any interfering iridescence or visible variation in coloring).

The applicant observed that the barrier layer thus formed, although compact and not containing any pores in the sense of the term understood with respect to unsealed layers, behaved like a fine anodic layer (less than hum) as concerns the adhesion of the varnish and its resistance to scratching and abrasion during subsequent folding or shaping operations.

The varnish may be glossy, e.g., of the type BASF C149-0005, in order to preserve a mirror finish on the final product, or flat, e.g., of the type BASF C149-0004, for a satin finished appearance.

Finally, during all of the experimental sublimation transfers of images, the applicant also observed an image quality that can be described as photographic, as concerns both its definition as well as the restitution of the colors, and this was done on a particularly favorable mirror finish substrate.

The explanation for this quite probably lies in the absence of pores in both the sealed anodic layers as well as the barrier-type layers of the HELIA® method: all of the pigments are distributed evenly within the varnish and on the anodized surface, without occurrence of the phenomenon of surface accumulation of pigments that are too large in size and diffusion of the others into the pores, as in the case of the porous layers; this characteristic affects both the accuracy of the colors restored in comparison with the initial substrate as well as the definition and clarity of the image (sharpness of the edges); the possible texture of the starting substrate does not appear either on the final image.

This characteristic also broadens the palette of inks or pigments that can be used. In addition, the thinness of the (conventional sealed or barrier) anodic layer guarantees the absence of visible crazing during the sublimation operation and also has a very positive influence on the folding and shaping characteristics of the final product.

Said final product further proves to be very resistant to corrosion when tested in a salt spray.

Finally, handling the strip coils prior to varnishing and prior to the sublimation transfer operation is carried out in a entirely conventional manner, due to the absence of pores that might become sealed, and to the high degree of resistance of the varnish, after it has been applied and prior to the transfer operation; possible wait times between anodic treatment of the strip coils and varnishing, as well as between varnishing and the transfer operation, have no effect here on the final quality of the product, which constitutes a serious advantage from the standpoint of the industrial robustness of the method.

### EXAMPLES

1) Rough-rolled, “high gloss” quality aluminium alloy coils of the “1085 Surface 310” type by Alcan-Singen, and the “1085 126.2” type by Amag, were degreased and then treated according to the HELIA® method, alternative 1 of the patent EP 0,745,703 (i.e.: electropolishing, phosphoric acid/chromic acid deoxidation, superfinishing with a barrier layer).

They were then continuously coated with the glossy varnish BASF C149-0005 on a so-called “coil coating” line 600 mm wide, at a rate of 25 m/min, the temperature of the varnish curing oven being 240° C.; the “wet thickness” of the varnish being approximately 50 μm with a “dry thickness” of approximately 15 to 20 μm.

The characterizations comprised optical measurements, measurements of the adhesion of the varnish and of resistance to corrosion in a salt spray.
a. Optical measurements: they dealt with the total reflectivity Rt and the diffuse reflectivity Rd using an Ulbricht sphere according to the standard DIN 5036, as well as with the specular reflectivity at 60 degrees in the lengthwise and crosswise rolling directions, Rs60L and Rs60T, according to the standard DIN 67530.
b. Adhesion of the varnish: the adhesion tests performed are the cross-cut tests defined by the standard ISO 2409 (1992).
c. Salt spray: this involves retention for more than 1,000 hours in a neutral salt spray chamber, a test in accordance with the standards ASTM B117, ASTM G85 A1 and ISO/DP 9227, with the following parameters:
   Spray temperature: 35° C.
   NaCl concentration of the solution: 50 g/l
   pH of the solution: 7
   Vertical tilt of the samples: 15 degrees
   Flow rate of the spray: 1.5 cm³/hour collected with a 10-cm diameter funnel.

The same tests were carried out but, in this case, using the flat varnish BASF C149-0004.

Results

a. Optical Measurements:
Glossy varnish: Rt=85, Rd=9, Rs60L=76, Rs60T=75
Flat varnish: Rt=83, Rd=69, Rs60L=35, Rs60T=35

After the glossy varnish operation, the surface has all of the characteristics of the mirror finish, namely high total and specular reflectivity values associated with a low diffuse reflectivity value.

The flat varnish offers an interesting alternative corresponding to a satin finish appearance with a high total reflectivity value.

b. Adhesion of the Varnish:

The adhesion of the coating to the substrate corresponds in both cases to Class O of the standard ISO 2409 (1992): perfectly smooth incision edges, none of the squares of the grid are detached.

c. Salt Spray:

The samples were recovered intact after more than 1,000 hours.

2) After degreasing and continuous electrochemical polishing, other rough-rolled “high gloss” quality aluminium alloy strips of the “1085 Surface 210” type by Alcan-Singen underwent a likewise continuous anodizing treatment in a sulphuric acid-based bath, and over a thin layer having a thickness of approximately 0.8 μm, followed by a still continuous pore-sealing operation via immersion in boiling water, an operation known by the name of boehmiting.

Half of them were then coated with the glossy varnish BASF C149-0005, and the other half with the flat varnish BASF C149-0004, continuously on a so-called “coil coating” line 600 mm wide, at a rate of 25 m/min, the temperature of the varnish curing oven being 240 C; the “wet thickness” of the varnish was approximately 50 μtm with a “dry thickness” of approximately 15 to 20 μm.

The characterizations comprised the same optical measurements, measurements of the adhesion of the varnish and of the resistance to corrosion in a salt spray.

Results:

a. Optical Measurements:
Glossy varnish: Rt=85, Rd=13, Rs60L=76, Rs60T=76
Flat varnish: Rt=84, Rd=77, Rs60L=27, Rs60T=26

After the glossy varnish operation, as previously, the surface has all of the mirror finish characteristics, namely high total and specular reflectivity values associated with a low diffuse reflectivity value.

In the same way as for the previous tests, the flat varnish offers an interesting alternative corresponding to a satin finish appearance but with a high total reflectivity value.

b. Adhesion of the Varnish:

The adhesion of the coating to the substrate corresponds in both cases to Class O of the standard ISO 2409 (1992): perfectly smooth incision edges, none of the squares of the grid are detached.

c. Salt Spray:

The samples were recovered intact after more than 1,000 hours.

In conclusion, the tests proved to be entirely positive, as were the various sublimation transfers carried out at 215° C. for 30 to 40 seconds: numerous images, differing by both the nature and density of the patterns and colors, were reproduced with a completely remarkable degree of sharpness and definition.

1. A method of continuous manufacture of an aluminium alloy strip decorated by transfer of a sublimable decoration from a temporary carrier, the method comprising:
a. preparation of a highly reflective aluminium alloy strip having a “glossy” or “high gloss” quality,
b. degreasing and polishing of the strip wherein the polishing consists of chemical polishing or electropolishing,
c. creation of a non-porous surface layer on the strip, wherein the non-porous surface layer is created by either (1) conventional anodization, followed by a sealing operation, via boehmiting, or (2) electrolytic superfinishing comprising, anodizing in a mineral, organic or compound acid, and wherein the non-porous surface layer comprises an oxide layer having a thickness of no more than 1 μm, and
d. coating of the strip with a transparent, varnish comprising a polyester and polyurethane mixture base.

2. The method of claim 1, further comprising deoxidation of the strip in a phosphoric acid/chromic acid medium after the polishing step and before the step of creation of a non-porous surface layer, wherein the deoxidation, selectively strips any oxide layer formed on the strip during the polishing step.

3. The method of claim 2, further comprising the steps of a second polishing step after the deoxidation and a second deoxidation after the second polishing step.

4. (canceled)

5. (canceled)

6. (canceled)

7. (canceled)

8. An aluminium alloy strip or sheet decorated by transfer of a sublimable decoration from a temporary carrier, manufactured according to the method described by claim 1.

9. An aluminium alloy strip or sheet decorated by transfer of a sublimable decoration from a temporary carrier, manufactured according to the method described by claim 3.

10. The method of claim 1 wherein the non-porous surface layer is a compact, barrier-type layer having a thickness ranging between 140 and 200 nm.

11. The method of claim 2 wherein the non-porous surface layer is a compact, barrier-type layer having a thickness ranging between 140 and 200 nm.

12. The method of claim 3 wherein the non-porous surface layer is a compact, barrier-type layer having a thickness ranging between 140 and 200 nm.
